(19) United States
(12) Patent Application Publication
(10) Pub. No.: US 2009/0171675 A1
(43) Pub. Date: Jul. 2, 2009

(54) DECODING REPRODUCTION APPARATUS AND METHOD AND RECEIVER

(75) Inventors: Kiyohiko Horichi, Kanagawa (JP); Akifumi Mizukami, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/343,103

(22) Filed: Dec. 23, 2008

(30) Foreign Application Priority Data
Dec. 28, 2007 (JP) 2007-340782

(51) Int. Cl. G10L 21/00; H04L 27/00

(52) U.S. Cl. 704/500; 375/316

(57) ABSTRACT

A decoding reproduction apparatus has an input memory buffer to which audio data asynchronously transmitted is input, a decoding circuit which is configured to read out and decode encoded data stored in the input memory buffer, an output memory buffer which is configured to store an output from the decoding circuit, and an output control circuit which is configured to monitor an amount of use of the input memory buffer, to output the data stored in the output memory buffer by decimation the data when the amount of use becomes larger than a predetermined upper-limit threshold value, and to output the data stored in the output memory buffer by interpolating the data when the amount of use becomes smaller than a predetermined lower-limit threshold value. Occurrence of an overflow or an underflow in the buffer as a result of D/A conversion of the audio data synchronously transmitted is prevented.

### CROSS REFERENCE TO RELATED APPLICATION

This application is based upon and claims the benefit of priority from the prior Japanese Patent Application No. 2007-340782 filed on Dec. 28, 2007; the entire contents of which are incorporated herein by reference.

### BACKGROUND OF THE INVENTION

1. Field of the Invention

The present invention relates to a decoding reproduction apparatus and method and a receiver suitable for decoding and reproduction of voice-coded data asynchronously transmitted.

2. Description of Related Art

In recent years, portable audio apparatuses have come into widespread use. In general, a portable audio apparatus is designed by assuming that a reproduced sound is listened to by using a headset, and the apparatus has a configuration in which an audio signal reproduction/output section and a headset are connected to each other by a cable or the like. Apparatuses using a Bluetooth headset or the like and configured to transmit audio data between a reproduction/output section and the headset have also been introduced into the market in recent years. When audio data is transmitted, encoding processing using the MP3 (MPEG Audio Layer-3) standard or the like is performed on the data to reduce the amount of data.

An analog audio signal is converted into a digital audio signal by sampling using a sampling clock from a clock generator. Also, a digital audio signal is converted into an analog signal by using a sampling clock from a clock generator. For example, in a case where sound quality corresponding to that of CD (Compact Disk) is required, a frequency of 44.1 kHz is selected as a sampling clock.

In a digital audio apparatus having an analog input, a clock generator is provided to enable A/D conversion. An audio apparatus having only a digital input or for reproduction only presupposes A/D conversion processing performed in an apparatus which produces a digital audio signal. In the above-mentioned Bluetooth headset, a clock generator is provided to perform D/A conversion of a received digital audio signal.

That is, in an apparatus which transmits a digital audio signal, converts the transmitted digital audio signal into an analog signal and outputs the sound, different clock generators are respectively used for A/D conversion and D/A conversion. In such a case, synchronized transmission may be performed in such a manner that a component of a sampling clock is transmitted simultaneously with audio data at the time of transmission of the digital audio data, and processing on the receiving side is performed by reproducing the sampling clock in the clock generator from the transmitted sampling clock component.

In a wireless transmission system based on the above-mentioned Bluetooth standard or the like, however, it is difficult to transmit a clock component, and the clock generator on the receiving side generates its particular sampling clock. Even with such asynchronous transmission, there is no particularly considerable problem if the clock generator used at the time of A/D conversions and the clock generator used at the time of D/A conversion oscillate sampling clocks of the same frequency. However, a slight difference may exist between the sampling clocks due to a difference between the individualities of the clock generators. Therefore, there is a possibility of occurrence of an overflow or an underflow in the input buffer on the receiving side where the digital audio signal is received. A fault such as an instantaneous break of a sound results therefrom.

In Japanese Patent Application Laid-Open Publication No. 2002-268662 (hereinafter referred to as document 1), a way to solve this problem has been proposed. In an apparatus described in document 1, received digital audio data is decoded by an expansion circuit and the decoded data is supplied to a digital signal processor and a D/A converter via a buffer memory. The digital signal processor thins out or interpolates an output from a buffer so that the amount of data remaining in the buffer memory is maintained within a certain range, thus preventing the occurrence of a fault such as a break of a sound output.

The apparatus described in document 1, however, needed use of a buffer memory having comparatively large capacity for control such that the amount of data remaining in the buffer memory is maintained within a certain range, and had a problem that the circuit scale was increased.

### BRIEF SUMMARY OF THE INVENTION

According to one aspect of the present invention, there is provided a decoding reproduction apparatus includes an input memory buffer to which audio data asynchronously transmitted is input, a decoding circuit which is configured to read out and decode encoded data stored in the input memory buffer, an output memory buffer which is configured to store an output from the decoding circuit, and an output control circuit which is configured to read out data stored in the output memory buffer while monitoring an amount of use of the input memory buffer, and which is configured to output the data read out from the output memory buffer while controlling a rate of output of the read data on the basis of a magnitude of the amount of use of the input memory buffer.

According to another aspect of the present invention, there is provided a receiver includes a decoding reproduction apparatus, an A/D conversion circuit which is configured to convert an output from the output control circuit into an analog signal, and a clock generator which is configured to supply a sampling clock to the A/D conversion circuit.

According to still another aspect of the present invention, there is provided a decoding reproduction method includes holding, in an input memory buffer, audio data asynchronously transmitted, reading out and decoding encoded data stored in the input memory buffer, storing, in an output memory buffer, data obtained by decoding the encoded data, and reading out the data stored in the output memory buffer while monitoring an amount of use of the input memory buffer and outputting the data read out from the output memory buffer while controlling a rate of output of the read data on the basis of a magnitude of the amount of use of the input memory buffer.

### BRIEF DESCRIPTION OF THE DRAWINGS

FIG. 1 is a block diagram showing an audio apparatus including a decoding reproduction apparatus according to a first embodiment of the present invention;

FIG. 2 is a graph in which the abscissa represents time and the ordinate represents the amount of use of an input memory buffer 23, and which is for explanation of output control performed by an output control circuit 26;

FIG. 3 is a flowchart for explanation of the operation of a decoding circuit 24;

FIG. 4 is a flowchart for explanation of the operation of the output control circuit 26;

FIG. 5 is a block diagram showing a second embodiment of the present invention;

FIG. 6 is a diagram for explanation of a rate change operation in an asynchronous sampling rate converter; and

FIG. 7 is a block diagram showing a third embodiment of the present invention.

### DETAILED DESCRIPTION OF THE INVENTION

Embodiments of the present invention will be described in detail with reference to the accompanying drawings.

### First Embodiment

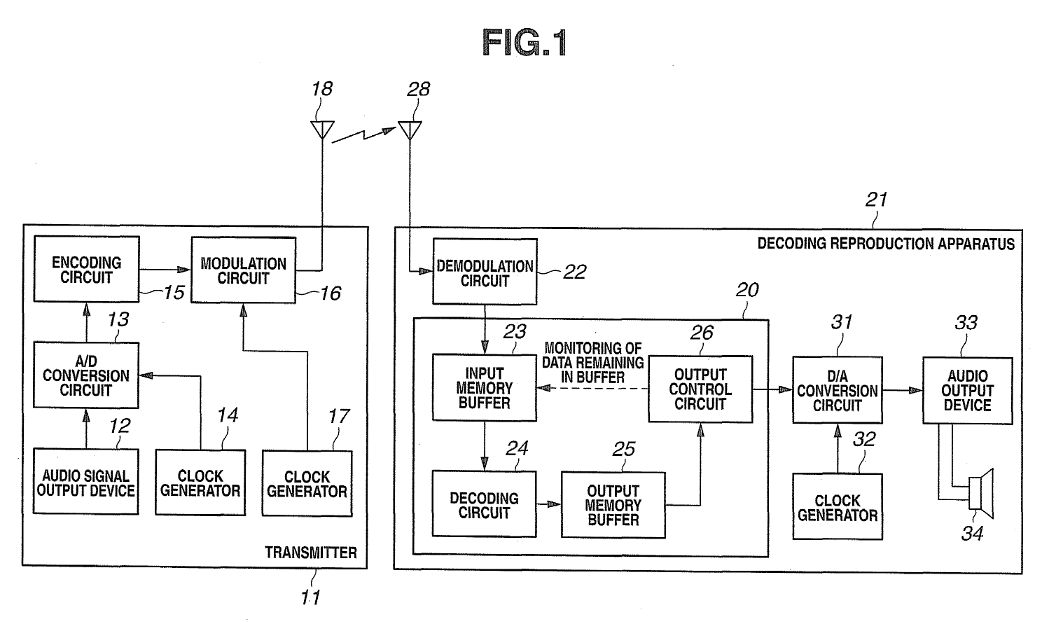

FIG. 1 is a block diagram showing an audio apparatus including a decoding reproduction apparatus according to a first embodiment of the present invention. In the present embodiment, the invention is applied to an apparatus which asynchronously transmits digital audio data. Description will be made of an example of an apparatus using wireless transmission system in accordance with the Bluetooth standard.

A transmitter 11 is provided with an audio signal output device 12. The audio signal output device 12 outputs an analog audio signal, which is supplied to an A/D conversion circuit 13. The A/D conversion circuit 13 is supplied with a sampling clock from a clock generator 14. The A/D conversion circuit 13 samples the input analog audio signal by using the sampling clock to convert the analog audio signal into a digital audio signal, and outputs the digital audio signal to an encoding circuit 15. The clock generator 14 generates a sampling clock having a predetermined frequency.

The audio signal output device 12 may be configured separately from the transmitter 11. In such a case, an analog input port is provided in the transmitter 11 and an audio signal from the analog input port is supplied to the A/D conversion circuit 13. Also, the audio signal output device 12 and the A/D conversion circuit 13 may be configured separately from the transmitter 11. In such a case, a digital input port is provided in the transmitter 11 and a digital audio signal from the digital input port is supplied to the encoding circuit 15.

The encoding circuit 15 performs predetermined encoding processing on the digital audio signal. For example, the encoding circuit 15 converts the input digital audio signal into encoded data in accordance with the MP3 standard or the like and outputs the encoded data. The encoded data from the encoding circuit 15 is supplied to a modulation circuit 16. The modulation circuit 16 modulates a carrier, which is a clock signal from a clock generator 17, with the encoded data, and outputs the resulting data as data to be transmitted. The data to be transmitted from the modulation circuit 16 is wirelessly transmitted through an antenna 18. In the present embodiment, data to be transmitted contains no sampling clock component of the audio signal.

On the other hand, in the decoding reproduction apparatus 21 on the receiving side, a signal induced in an antenna 28 is taken in. The antenna 28 receives the data transmitted from the antenna 18 of the transmitter 11 and outputs the received data to a demodulation circuit 22. The demodulation circuit 22 performs demodulation processing associated with the modulation processing in the modulation circuit 16 in the transmitter 11 to obtain the encoded data before modulation. The demodulation circuit 22 outputs to a decoding section 20 the encoded data obtained by demodulation processing.

The decoding section 20 is configured of a digital signal processor (DSP). The encoded data from the demodulation circuit 22 is input to an input memory buffer 23 in the decoding section 20. The input memory buffer 23 holds the input encoded data and outputs the held encoded data to a decoding circuit 24 according to a demand from the decoding circuit 24.

The decoding circuit 24 decodes the input encoded data to restore the audio data before encoding, and outputs the audio data to an output memory buffer 25. In such a case, the decoding circuit 24 decodes a predetermined number of samples of the audio data all together and outputs the decoded data. When a free space for a predetermined number of samples, e.g., 512 samples is produced in the output memory buffer 25, the decoding circuit 24 reads out the encoded data from the input memory buffer 23, decodes the data and outputs the decoded data to the output memory buffer 25. The output memory buffer 25 temporarily holds the decoded audio data. The output memory buffer 25 outputs the accumulated audio data to an output control circuit 26 while readout from the output memory buffer 25 is being controlled by the output control circuit 26.

The output control circuit 26 can monitor the amount of data remaining in the input memory buffer 23, control readout of audio data from the output memory buffer 25 on the basis of the result of this monitoring, and perform decimation or interpolation processing on the audio data from the output memory buffer 25. An output from the output control circuit 26 is supplied to a D/A conversion circuit 31.

For example, the output control circuit 26 sets a threshold value (lower-limit threshold value) with respect to underflowing in the input memory buffer 23. When the amount of use of the input memory buffer 23 becomes smaller than the lower-limit threshold value, the output control circuit 26 interpolates a one-sample amount of audio data in the audio data from the output memory buffer 25 and supplies the resulting audio data to the D/A conversion circuit 31. Also, for example, the output control circuit 26 sets a threshold value (upper-limit threshold value) with respect to overflowing in the input memory buffer 23. When the amount of use of the input memory buffer 23 becomes higher than the upper-limit threshold value, the output control circuit 26 thins out the audio data from the output memory buffer 25 by a one-sample amount of audio data and supplies the resulting audio data to the D/A conversion circuit 31.

The D/A conversion circuit 31 converts the audio data supplied from the decoding section 20 into an analog signal. For this conversion, the D/A conversion circuit 31 uses a sampling clock from a clock generator 32. The clock generator 32 generates a sampling clock of substantially the same frequency as that of the sampling clock from the clock generator 14 of the transmitter 11. The sampling clock from the clock generator 32 is asynchronous with the sampling clock from the clock generator 14 and a slight difference exists between the frequencies of these clocks. The analog audio signal from the D/A conversion circuit 31 is supplied to an audio output device 33. The audio output device 33 supplies the input audio signal to a speaker 34 to output sound.

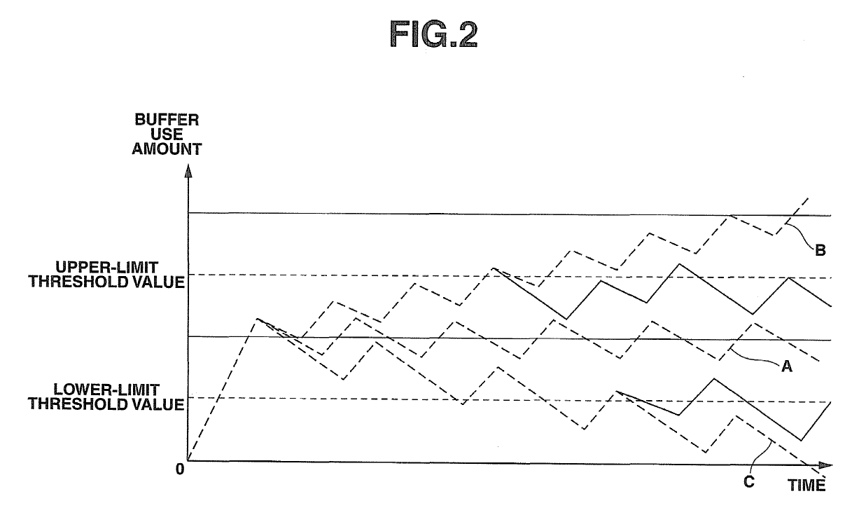

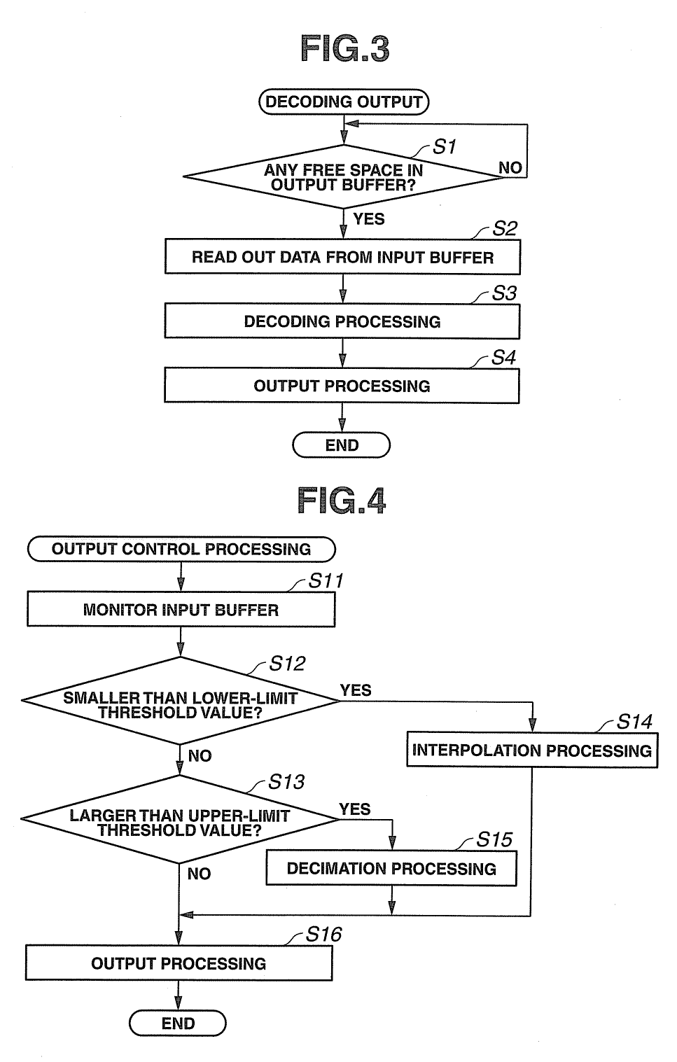

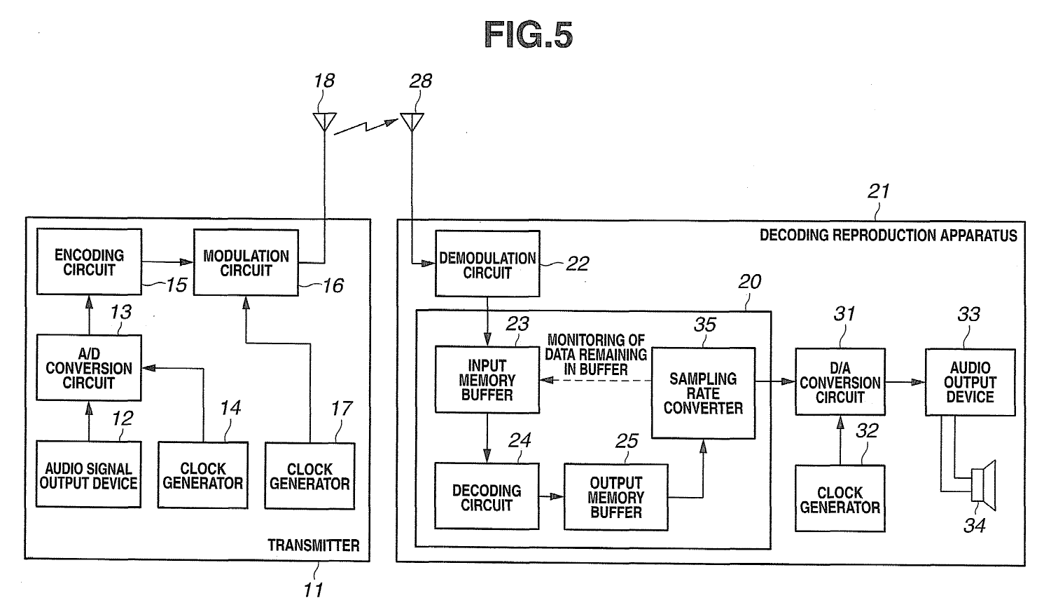

The operation of the embodiment thus configured will be described with reference to FIGS. 2 to 4. FIG. 2 is a graph in which the abscissa represents time and the ordinate represents the amount of use of the input memory buffer 23, and which is for explanation of output control performed by the output control circuit 26. FIG. 3 is a flowchart for explanation of the operation of the decoding circuit 24. FIG. 4 is a flowchart for explanation of the operation of the output control circuit 26.

The output control circuit 26 sets a suitable range as an amount of data accumulation in the input memory buffer 23, sets the upper limit of the range as an upper-limit threshold value with respect to overflowing and sets the lower limit of the range as a lower-limit threshold value with respect to underflowing. The demodulation circuit 22 demodulates received data and outputs encoded data to the decoding section 20. This encoded data is temporarily accumulated in the input memory buffer 23 and is thereafter read out by the decoding circuit 24. In step S1 in FIG. 3, the decoding circuit 24 performs detection to determine whether or not a predetermined free space exists in the output memory buffer 25. If the predetermined free space, e.g., a free space for 512 samples of audio data exists in the output memory buffer 25, the decoding circuit 24 reads out the encoded data from the input memory buffer 23 (step S2) and performs decoding processing (step S3). The decoding circuit 24 outputs the decoded audio data to the output memory buffer 25 (step S4).

In the present embodiment, the output control circuit 26 monitors the amount of data remaining in the input memory buffer 23 (the amount of use of the buffer 23) (step S11). If the amount of use of the input memory buffer 23 is equal to or larger than the lower-limit threshold value in step S12 and equal to or smaller than the upper-limit threshold value in step S13, the output control circuit 26 directly reads out the audio data accumulated in the output memory buffer 25 and outputs the read data to the D/A conversion circuit 31.

If the amount of use of the input memory buffer 23 is smaller than the lower-limit threshold value in step S12, the output control circuit 26 interpolates a one-sample amount of audio data in the audio data accumulated in the output memory buffer 25 and outputs the resulting data to the D/A conversion circuit 31 (step S14). If the amount of use of the input memory buffer 23 is larger than the upper-limit threshold value in step S13, the output control circuit 26 thins out the audio data accumulated in the output memory buffer 25 by a one-sample amount of audio data and outputs the resulting data to the D/A conversion circuit 31 (step S15).

The D/A conversion circuit 31 converts the input audio data into an analog signal by using the sampling clock from the clock generator 32. That is, the D/A conversion circuit 31 performs digital/analog conversion by using the sampling clock asynchronous with the sampling clock used at the time of A/D conversion of the audio data. If the frequency of the sampling clock from the clock generator 32 is higher than the frequency of the sampling clock at the time of A/D conversion, the audio data is converted into the analog signal at a higher rate. If the frequency of the sampling clock from the clock generator 32 is lower than the frequency of the sampling clock at the time of A/D conversion, the audio data is converted into the analog signal at a lower rate. The rate of transmission of data transmitted to the decoding reproduction apparatus 21 is determined on the transmitting side. Therefore, the average amount of data remaining in the input memory buffer 23 is changed by the frequency of the sampling clock.

FIG. 2 is a diagram for explanation of changes in the amount of data remaining in the input memory buffer 23. Characteristics A to C (broken lines) in FIG. 2 represent an example of characteristics in a case where audio data is directly output from the output memory buffer 25 to the D/A conversion circuit 31 without performing any of interpolation and decimation processing, no matter what the amount of data remaining in the input memory buffer 23 (the amount of use of the buffer 23). A solid line in FIG. 2 indicates a case where interpolation or decimation processing is performed by the output control circuit 26. In FIG. 2, changes in the amount of use are schematically shown without regard to circumstances including changes in the data rate of the encoded data, the processing speed of the demodulation circuit 22 and the method of decoding in the decoding circuit 24, and conditions including timing of control of interpolation or decimation are different from the actual ones.

Characteristic A indicated by the broken line in FIG. 2 represents an example of a case where the frequency of the sampling clock to the D/A conversion circuit 31 is equal to the frequency of the sampling clock at the time of A/D conversion on the transmitting side, for example, a case where synchronized transmission is performed. In this case, the D/A conversion circuit 31 restores the analog signal from the audio data at the original rate. Accordingly, the average amount of data taken in the input memory buffer 23 from the demodulation circuit 22 and the average amount of data read out from the input memory buffer 23 by the decoding circuit 24 are equal to each other, and there is no possibility of occurrence of an overflow or an underflow in the input memory buffer 23.

Characteristic B indicated by the broken line in FIG. 2 represents an example of a case where the frequency of the sampling clock to the D/A conversion circuit 31 is lower than the frequency of the sampling clock at the time of A/D conversion on the transmitting side. In this case, the D/A conversion circuit 31 restores the analog signal from the audio data at a rate lower than the original rate. In this case, therefore, the average amount of data taken in the input memory buffer 23 from the demodulation circuit 22 is larger than the average amount of data read out from the input memory buffer 23 by the decoding circuit 24, and the input memory buffer 23 overflows.

Characteristic C indicated by the broken line in FIG. 2 represents an example of a case where the frequency of the sampling clock to the D/A conversion circuit 31 is higher than the frequency of the sampling clock at the time of A/D conversion on the transmitting side. In this case, the D/A conversion circuit 31 restores the analog signal from the audio data at a rate higher than the original rate. In this case, therefore, the average amount of data taken in the input memory buffer 23 from the demodulation circuit 22 is smaller than the average amount of data read out from the input memory buffer 23 by the decoding circuit 24, and an underflow occurs in the input memory buffer 23.

As described above, if the amount of use of the input memory buffer 23 becomes higher than the upper-limit threshold value, the output control circuit 26 thins out the audio data in the output memory buffer 25 by a one-sample amount. Readout of the audio data from the input memory buffer 23 performed by the decoding circuit 24 is thereby sped up by the one-sample amount. As a result, the amount of use of the input memory buffer 23 is reduced from the state indicated by the broken line in FIG. 2, as indicated by the solid line in FIG. 2. The occurrence of an overflow in the input memory buffer 23 can be prevented in this way.

Conversely, if the amount of use of the input memory buffer 23 becomes lower than the lower-limit threshold value, the output control circuit 26 interpolates one-sample amount of audio data in the audio data in the output memory buffer 25. Readout of the audio data from the input memory buffer 23 performed by the decoding circuit 24 is thereby delayed by the one-sample amount. As a result, the amount of use of the input memory buffer 23 is increased from the state indicated by the broken line in FIG. 2, as indicated by the solid line in FIG. 2. The occurrence of an underflow in the input memory buffer 23 can be prevented in this way.

If only processing for one-sample-amount interpolation or decimation is performed on the audio data, there is a tendency of a degradation of the sound quality. Therefore, the output control circuit 26 may perform suitable audio signal processing so that the audio signal is continuous when interpolation or decimation processing is performed.

In the present embodiment, as described above, the amount of data remaining in the input memory buffer (the amount of use of the buffer) is monitored, processing for interpolating or decimation the decoded audio data is performed when the amount of use becomes higher than the upper-limit threshold value or lower than the lower-limit threshold value, and D/A conversion processing is thereafter performed. In this way, decoding and reproduction of sound can be performed while preventing the occurrence of an overflow or an underflow even in a case where a memory having a comparatively small capacity is used as the input memory buffer.

### Second Embodiment

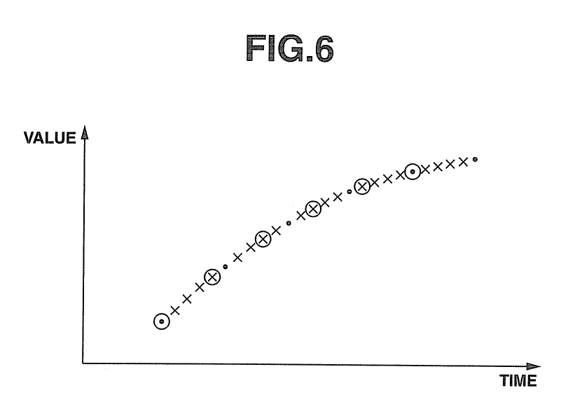

FIG. 5 is a block diagram showing a second embodiment of the present invention. FIG. 6 is a diagram for explanation of a rate change operation in an asynchronous sampling rate converter.

The second embodiment differs from the first embodiment in that an asynchronous sampling rate converter 35 is used as the output control circuit 26. The asynchronous sampling rate converter 35 monitors the amount of data remaining in an input memory buffer 23 (the amount of use of the buffer 23). When the amount of data remaining in the buffer (the amount of use of the buffer) becomes larger than the upper-limit threshold value, the asynchronous sampling rate converter 35 converts audio data to a lower sampling rate (decimation processing). When the amount of data remaining in the buffer (the amount of use of the buffer) becomes smaller than the lower-limit threshold value, the asynchronous sampling rate converter 35 converts audio data to a higher sampling rate (interpolation processing).

In FIG. 6, solid round marks represent decoded audio data. The asynchronous sampling rate converter 35 performs interpolation or decimation processing to change the rate of sampling of audio data indicated by solid round marks. In this case, the asynchronous sampling rate converter 35 smoothly changes the number of samples so as not to cause a degradation of the sound quality as a result of interpolation or decimation processing. That is, the asynchronous sampling rate converter 35 first interpolates the audio data. Marks x in FIG. 6 represent audio data obtained by interpolation. The asynchronous sampling rate converter 35 then selects the original audio data and the audio data obtained by interpolation according to the changed sampling rate, and outputs the selected audio data. Circular marks in FIG. 6 represent the output audio data. FIG. 6 shows an example of output of six audio data items with respect to five original audio data items before interpolation, that is, a case where the sampling rate is increased (interpolation processing).

For example, it is assumed that the amount of data remaining in the buffer (the amount of use of the buffer) becomes smaller than the lower-limit threshold value. In this case, the asynchronous sampling rate converter 35 increases the rate of sampling of the audio data in an output memory buffer 25, as in the case shown in FIG. 6, and outputs the resulting data to a D/A conversion circuit 31. Readout of the voice-coded data from the input memory buffer 23 performed by a decoding circuit 24 is thereby delayed to prevent the occurrence of an underflow in the input memory buffer 23.

Conversely, it is assumed that the amount of data remaining in the buffer (the amount of use of the buffer) becomes larger than the upper-limit threshold value. In this case, the asynchronous sampling rate converter 35 reduces the rate of sampling of the audio data in the output memory buffer 25 and outputs the resulting data to the D/A conversion circuit 31. That is, this processing is equivalent to decimation the audio data from the decoding circuit 24 and supplying the thinned-out data to the D/A conversion circuit 31. Readout of the voice-coded data from the input memory buffer 23 performed by the decoding circuit 24 is sped up to prevent the occurrence of an overflow in the input memory buffer 23.

Thus, the present embodiment has the same advantage as that of the first embodiment.

While the embodiments have been described with respect to an example of application to a Bluetooth network provided as a wireless network, the present invention can also be applied to other kinds of wireless network.

### Third Embodiment

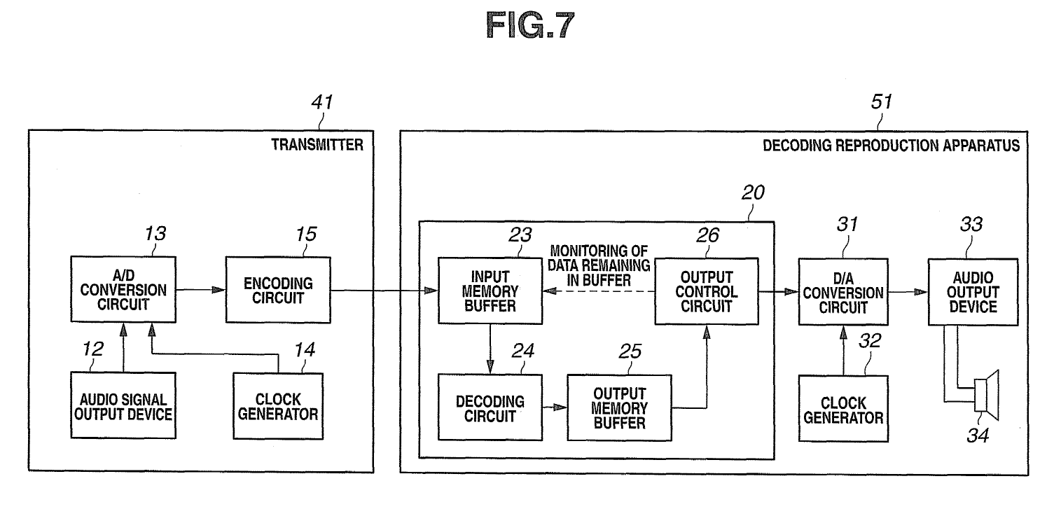

FIG. 7 is a block diagram showing a third embodiment of the present invention. The third embodiment is an example of application to wired transmission.

The third embodiment differs from the first embodiment in that a transmitter 41 configured without the modulation circuit 16 and the clock generator 17 is adopted on the transmitting side while a decoding reproduction apparatus 51 configured without the demodulation circuit 22 is adopted on the receiving side.

An encoding circuit 15 in the transmitter 41 encodes an input digital audio signal and outputs the encoded data to a decoding section 20 in the decoding reproduction apparatus 51 via a wired transmission path. An input memory buffer 23 in the decoding section 20 temporarily holds the voice-coded data from the transmitter 41 and outputs the held encoded data to a decoding circuit 24 according to a demand from the decoding circuit 24. In other respects, the configuration is the same as that of the first embodiment.

In the embodiment thus configured, voice-coded data is input to the input memory buffer 23 of the decoding reproduction apparatus 51. Also in this case, the output control circuit 26 monitors the amount of data remaining in the input memory buffer 23 (the amount of use of the buffer 23) and controls interpolation processing or decimation processing on audio data in an output memory buffer 25 on the basis of the monitoring result, as does that in the first embodiment.

Other functions and effects are the same as those in the first embodiment.

In each of the above-described embodiments, interpolation processing or decimating processing is controlled according to whether or not the amount of use of the input memory buffer 23 exceeds the upper-limit threshold value or the lower-limit threshold value. However, the interpolation processing or the decimation processing may be performed by following changes in the amount of use of the input memory buffer 23.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A decoding reproduction apparatus comprising:
an input memory buffer to which audio data asynchronously transmitted is input;
a decoding circuit which is configured to read out and decode encoded data stored in the input memory buffer;
an output memory buffer which is configured to store an output from the decoding circuit; and
an output control circuit which is configured to read out data stored in the output memory buffer while monitoring an amount of use of the input memory buffer, and which is configured to output the data read out from the output memory buffer while controlling a rate of output of the read data on the basis of a magnitude of the amount of use of the input memory buffer.

2. The decoding reproduction apparatus according to claim 1, wherein the output control circuit monitors the amount of use of the input memory buffer, outputs the data stored in the output memory buffer by performing decimation processing on the data when the amount of use becomes larger than a predetermined upper-limit threshold value, and outputs the data stored in the output memory buffer by performing interpolation processing on the data when the amount of use becomes smaller than a predetermined lower-limit threshold value.

3. The decoding reproduction apparatus according to claim 2, wherein the output control circuit performs the decimation processing and the interpolation processing on the audio data by an amount corresponding one sample of the audio data.

4. The decoding reproduction apparatus according to claim 1, wherein the output control circuit is configured of an asynchronous sampling rate converter.

5. The decoding reproduction apparatus according to claim 4, wherein the asynchronous sampling rate converter interpolates the data read out from the output memory buffer and selects the interpolated data on the basis of the output rate.

6. The decoding reproduction apparatus according to claim 1, wherein the output control circuit controls the output rate while performing predetermined audio signal processing on the data read out from the output memory buffer.

7. The decoding reproduction apparatus according to claim 1, wherein the decoding circuit reads out the audio data stored in the input memory buffer and performs decoding processing when a predetermined amount of free space is produced in the output memory buffer.

8. A receiver comprising:
the decoding reproduction apparatus according to claim 1;
an D/A conversion circuit which is configured to convert an output from the output control circuit into an analog signal; and
a clock generator which is configured to supply a sampling clock to the D/A conversion circuit.

9. The receiver according to claim 8, wherein the output control circuit monitors an amount of use of the input memory buffer, outputs the data stored in the output memory buffer by performing decimation processing on the data when the amount of use becomes larger than a predetermined upper-limit threshold value, and outputs the data stored in the output memory buffer by performing interpolation processing on the data when the amount of use becomes smaller than a predetermined lower-limit threshold value.

10. The receiver according to claim 8, wherein the output control circuit is configured of an asynchronous sampling rate converter.

11. The receiver according to claim 8, further comprising a demodulation section which is configured to receive and demodulate data asynchronously transmitted, and which is configured to supply encoded data to the input memory buffer.

12. The receiver according to claim 9, further comprising a demodulation section which is configured to receive and demodulate data asynchronously transmitted, and which is configured to supply encoded data to the input memory buffer.

13. The receiver according to claim 10, further comprising a demodulation section which is configured to receive and demodulate data asynchronously transmitted, and which is configured to supply encoded data to the input memory buffer.

14. A decoding reproduction method comprising:
holding, in an input memory buffer, audio data asynchronously transmitted;
reading out and decoding encoded data stored in the input memory buffer;
storing, in an output memory buffer, data obtained by decoding the encoded data; and
reading out the data stored in the output memory buffer while monitoring an amount of use of the input memory buffer, and outputting the data read out from the output memory buffer while controlling a rate of output of the read data on the basis of a magnitude of the amount of use of the input memory buffer.

15. The decoding reproduction method according to claim 14, wherein output of the data stored in the output memory buffer is performed by monitoring the amount of use of the input memory buffer, outputting the data stored in the output memory buffer by performing decimation processing on the data when the amount of use becomes larger than a predetermined upper-limit threshold value, and outputting the data stored in the output memory buffer by performing interpolation processing on the data when the amount of use becomes smaller than a predetermined lower-limit threshold value.

16. The decoding reproduction method according to claim 15, wherein output of the data stored in the output memory buffer is performed by performing decimation processing or the interpolation processing on the audio data by an amount corresponding one sample of the audio data.

17. The decoding reproduction method according to claim 14, wherein output of the data stored in the output memory buffer is performed by means of asynchronous sampling rate conversion.

18. The decoding reproduction method according to claim 17, wherein the asynchronous sampling rate conversion is made by interpolating the data read out from the output memory buffer and selecting the interpolated data on the basis of the output rate.

19. The decoding reproduction method according to claim 14, wherein output of the data stored in the output memory buffer is performed while performing predetermined audio signal processing on the data read out from the output memory buffer.

20. The decoding reproduction method according to claim 14, wherein the decoding is performed by reading out the audio data stored in the input memory buffer each time a predetermined amount of free space is produced in the output memory buffer.
